(19) United States
(12) Patent Application Publication
(10) Pub. No.: US 2023/0270139 A1
(43) Pub. Date: Aug. 31, 2023

(54) COMPOSITIONS TO PROMOTE SWALLOWING SAFETY AND EFFICIENCY

(71) Applicant: SOCIETE DES PRODUITS NESTLE S.A., Vevey (CN)

(72) Inventors: MICHAEL JEDWAB, Lausanne (CH); STEPHANIE MICHLIG GONZALEZ, Le Mont-sur-Lausanne (CH); BENJAMIN JEAN DIDIER LE REVEREND, Kirkwood, MO (US); SHREERAM SATHYAVAGEESWARAN, Singapore (SG); MELANIE FRANKS, Plainsboro, NJ (US)

(21) Appl. No.: 18/005,399

(22) PCT Filed: Jul. 12, 2021
(86) PCT No.: PCT/EP2021/069260

§ 371 Date: Jan. 13, 2023

Related U.S. Application Data
(60) Provisional application No. 63/052,023, filed on Jul. 15, 2020.

(51) Int. Cl. A23L 2/66; A23L 2/68; A23L 29/206

(52) U.S. Cl. CPC A23L 2/66; A23L 2/68; A23L 29/206

(57) ABSTRACT

The present disclosure relates to a tingling composition and the use thereof to provide trigeminal sensory stimulation at a dosage and a viscosity effective to improve the swallowing function of patients suffering from dysphagia. The present disclosure provides people suffering from dysphagia with a novel type of solution combining a thickening agent, a tingling composition, and optionally a trigeminal ingredient at the right concentrations. The present disclosure discloses, a tingling composition, specifically, an effervescent composition or an easy and/or fast dissolving thickener composition formulated for dilution into a nutritional product, a nutritional product made from the composition, a ready-to-drink (RTD) beverage, a use of the composition, a method for making a nutritional product from the composition, and a related system.

### BACKGROUND

Dysphagia is a medical term for the symptom of difficulty in swallowing. Dysphagia may be a sensation that suggests a difficulty in a passage of a solid or a liquid (i.e., a nutritional product) from the mouth to the stomach.

During processing of a nutritional product in the mouth and during swallowing, a viscosity of the nutritional product changes due to shear forces. In most cases, the viscosity of the nutritional product decreases when the shear forces and the shear rate acting on the nutritional product (e.g., chewing forces) increase. Individuals who suffer from dysphagia often require a thickened nutritional product. Thickening of the nutritional product is achieved to increase, in particular, the shear viscosity of the product by adding a thickener such as a starch or gum thickener. The thickened nutritional product makes an individual with dysphagia less likely to aspirate during passage of the nutritional products from the mouth to the stomach.

Individuals with dysphagia may find that nutritional products cause coughing, spluttering or even choking, and therefore thickened nutritional products enable the individuals who suffer from dysphagia to swallow safely. The addition of a thickener is thought to improve a bolus control and timing of swallowing, but the resultant thickness may be disliked by individuals who suffer from dysphagia due to the extra swallowing effort required. Moreover, the thickener leaves residues with high levels of viscosity, resulting in undesirable organoleptic properties. This is particularly relevant for liquids and beverages, as a dysphagia patient would expect a liquid that still has the organoleptic properties of a real thin liquid instead of a liquid product showing high viscosity. Furthermore, thickened nutritional products wherein merely shear viscosity is increased usually lack the cohesiveness that saliva typically provides to food boluses. Oral saliva has elastic, high extensional viscosity and plays an important role in bolus formation, promoting the bolus cohesiveness of masticated particles.

Dysphagia is classified into three major types: oropharyngeal dysphagia (OD), esophageal dysphagia (ED) and functional dysphagia (FD).

Oropharyngeal dysphagia is generally not treatable with medication. Oropharyngeal dysphagia affects individuals of all ages but is more prevalent in older individuals. Worldwide, oropharyngeal dysphagia affects approximately 22 million people over the age of 50 years. Oropharyngeal dysphagia is often a consequence of an acute event such as a stroke, brain injury, or surgery for oral or throat cancer. In addition, radiotherapy and chemotherapy may weaken the muscles and degrade the nerves associated with the physiology and nervous innervation of the swallow reflex. Oropharyngeal dysphagia is also common for individuals with progressive neuromuscular diseases, such as Parkinson's disease, to experience increasing difficulty in swallowing initiation. Representative causes of oropharyngeal dysphagia include those associated neurological illnesses (brainstem tumors, head trauma, stroke, cerebral palsy, Guillain-Barre syndrome, Huntington's disease, multiple sclerosis, polio, post-polio syndrome, Tardive dyskinesia, metabolic encephalopathies, amyotrophic lateral sclerosis, Parkinson's disease, dementia), infectious illnesses (diphtheria, botulism, Lyme disease, syphilis, mucositis [herpetic, cytomegalovirus, candida, etc.]), autoimmune illnesses (lupus, scleroderma, Sjogren's syndrome), metabolic illnesses (amyloidosis, Cushing's syndrome, thyrotoxicosis, Wilson's disease), myopathic illnesses (connective tissue 15 disease, dermatomyositis, myasthenia gravis, myotonic dystrophy, oculopharyngeal dystrophy, polymyositis, sarcoidosis, paraneoplastic syndromes, inflammatory myopathy), iatrogenic illnesses (medication side effects [e.g., chemotherapy, neuroleptics, etc.], post surgical muscular or neurogenic, radiation therapy, corrosive [pill injury, intentional]), and structural illnesses (cricopharyngeal bar, Zenker's diverticulum, cervical webs, oropharyngeal tumors, osteophytes and skeletal abnormalities, congenital [cleft palate, diverticulae, pouches, etc.]).

Esophageal dysphagia can affect individuals of all ages. Esophageal dysphagia is generally treatable with medications and is considered a less serious form of dysphagia. Esophageal dysphagia is often a consequence of mucosal, mediastinal, or neuromuscular diseases. Mucosal (intrinsic) diseases narrow the lumen through inflammation, fibrosis, or neoplasia associated with various conditions (e.g., peptic stricture secondary to gastroesophageal reflux disease, esophageal rings and webs [e.g., sideropenic dysphagia or Plummer-Vinson syndrome], esophageal tumors, chemical injury [e.g., caustic ingestion, pill esophagitis, sclerotherapy for varices], radiation injury, infectious esophagitis, and eosinophilic esophagitis). Mediastinal (extrinsic) diseases obstruct the esophagus by direct invasion or through lymph node enlargement associated with various conditions (tumors [e.g., lung cancer, lymphoma], infections [e.g., tuberculosis, histoplasmosis], and cardiovascular [dilated auricula and vascular compression]). Neuromuscular diseases may affect the esophageal smooth muscle and its innervation, disrupting peristalsis or lower esophageal sphincter relaxation, or both, commonly associated with various conditions (achalasia [both idiopathic and associated with Chagas disease], scleroderma, other motility disorders, and a consequence of surgery [i.e., after fundoplication and anti-reflux interventions]). Individuals with intraluminal foreign bodies commonly experience acute esophageal dysphagia.

Functional dysphagia is defined in some patients wherein no organic cause for dysphagia can be found.

Dysphagia is not generally diagnosed. Dysphagia has major consequences on health and healthcare costs on individuals who suffer from dysphagia. Individuals who suffer from severe dysphagia experience a sensation of impaired passage of nutritional products from the mouth to the stomach, occurring immediately after swallowing. Among community-dwelling individuals, perceived symptoms may bring the individuals who suffer from dysphagia to see a doctor. Among institutionalized individuals, healthcare practitioners may observe symptoms or hear comments from the individual who suffers from dysphagia or a family member suggestive of swallowing impairment and then recommend evaluation of the individual who suffers from dysphagia by a specialist. The general awareness of swallowing impairments is low among front-line practitioners, so dysphagia often is undiagnosed and untreated. Yet, a patient can be clinically evaluated and dysphagia diagnosis can be determined through referral to a swallowing specialist (e.g. speech language pathologist (SLP)).

The general awareness of swallowing impairments is low among front-line practitioners. Many people (especially those who are elderly) suffer with undiagnosed and untreated swallowing impairments. One reason is that front-line community care practitioners (e.g., general practitioners/geriatricians, home care nurses, physical therapists, etc.) do not typically screen for the condition. If they are aware of the severity of swallowing impairments, they commonly do not use an evidence-based method of screening.

A severity of dysphagia may vary from: (i) minimal (perceived) difficulty in safely swallowing nutritional products, (ii) an inability to swallow nutritional products without significant risk for aspiration or choking, and (iii) a complete inability to swallow nutritional products. An inability to properly swallow nutritional products may be due to food boluses of the nutritional products being broken into smaller fragments, which may enter the airway or leave unwanted residues in the oropharyngeal and/or esophageal tract during the swallowing process (e.g., aspiration). If enough material enters the lungs, the patient may drown on the nutritional products that have accumulated in the lungs. Even small volumes of aspirated nutritional products may lead to bronchopneumonia infection, and chronic aspiration may lead to bronchiectasis and may cause some cases of asthma. Swallowing efficiency is linked to the amount of residues in the throat.

Silent aspiration is a common condition among the elderly and refers to the aspiration of the oropharyngeal contents during sleep. People may compensate for less-severe swallowing impairments by self-limiting the diet. The aging process itself, coupled with chronic diseases such as hypertension or osteoarthritis, predisposes the elderly to sub-clinical dysphagia that may go undiagnosed and untreated until a clinical complication such as pneumonia, dehydration, malnutrition and related complications occurs.

Dysphagia and aspiration impacts upon quality of life, morbidity and mortality. Twelve-month mortality is high (45%) among individuals in institutional care who have dysphagia and aspiration. The economic burden of the clinical consequences arising from lack of diagnosis and early management of dysphagia are therefore significant.

As noted, pneumonia is a common clinical consequence of dysphagia. Pneumonia may require acute hospitalisation and emergency room visits. Among those that develop pneumonia due to aspiration, the differential diagnosis of ‘aspiration pneumonia’ is not necessarily indicated as a result of current care practices. Based on U.S. healthcare utilisation surveys from recent years, pneumonia accounted for over one million hospital discharges and an additional 392,000 were attributable to aspiration pneumonia. Individuals who have general pneumonia as the principal diagnosis have a mean 6-day hospital length of stay and incur over $18,000 in costs for hospital care. It is expected that aspiration pneumonia would carry higher costs for hospital care, based on a mean 8day length of hospital stay. Pneumonia is life-threatening among persons with dysphagia, the odds of death within 3 months being about 50% (van der Steen et al. 2002). In addition, an acute insult such as pneumonia often initiates the downward spiral in health among elderly. An insult is associated with poor intakes and inactivity, resulting in malnutrition, functional decline, and frailty. Specific interventions (e.g., to promote oral health, help restore normal swallow, or reinforce a swallow-safe bolus) would benefit persons at risk for (due to aspiration of oropharyngeal contents, including silent aspiration) or experiencing recurrent pneumonia. Swallowing safety is linked to aspiration pneumonia, quantified on the Penetration-Aspiration Scale (PAS) or Rosenbek scale.

Similar to pneumonia, dehydration is a life-threatening clinical complication of dysphagia. Dehydration is a common co-morbidity among hospitalised individuals with neurodegenerative diseases (thus, likely to have a swallowing impairment). The conditions of Alzheimer's disease, Parkinson's disease, and multiple sclerosis account for nearly 400,000 U.S. hospital discharges annually, and up to 15% of these patients suffer dehydration. Having dehydration as the principal diagnosis is associated with a mean 4-day length of hospital stay and over $11,000 in costs for hospital care. Nevertheless, dehydration is an avoidable clinical complication of dysphagia.

Malnutrition and related complications (e.g., [urinary tract] infections, pressure ulcers, increased severity of dysphagia [need for more-restricted food options, tube feeding, and/or Percutaneous Endoscopic Gastrostomy (PEG) tube placement and reduced quality of life], dehydration, functional decline and related consequences [falls, dementia, frailty, loss of mobility, and loss of autonomy]) can arise when swallowing impairment leads to fear of choking on food and liquids, slowed rate of consumption, and self-limited food choices. If uncorrected, inadequate nutritional intake exacerbates dysphagia as the muscles that help facilitate normal swallow atrophy as physiological reserves are depleted. Malnutrition is associated with having more than 3-times greater risk of infection. Infections are common in individuals with neurodegenerative diseases (thus, likely to have a chronic swallowing impairment that jeopardizes dietary adequacy). The conditions of Alzheimer's disease, Parkinson's disease, and multiple sclerosis account for nearly 400,000 U.S. hospital discharges annually, and up to 32% of these patients suffer urinary tract infection.

Malnutrition has serious implications for patient recovery. Malnourished patients have longer length of hospital stay, are more likely to be re-hospitalized, and have higher costs for hospital care. Having malnutrition as the principal diagnosis is associated with a mean 8 day length of hospital stay and nearly $22,000 in costs for hospital care. Furthermore, malnutrition leads to unintentional weight loss and predominant loss of muscle and strength, ultimately impairing mobility and the ability to care for oneself. With the loss of functionality, caregiver burden becomes generally more severe, necessitating informal caregivers, then formal caregivers, and then institutionalization. However, malnutrition is an avoidable clinical complication of dysphagia.

Among persons with neurodegenerative conditions (e.g., Alzheimer's disease), unintentional weight loss (a marker of malnutrition) precedes cognitive decline. In addition, physical activity can help stabilize cognitive health. Thus, nutritional adequacy is important among persons with neurodegenerative conditions to help them have the strength and endurance to participate in regular therapeutic exercise and guard against unintentional weight loss, muscle wasting, loss of physical and cognitive functionality, frailty, dementia, and progressive increase in caregiver burden.

Falls and related injuries are a special concern among elderly with neurodegenerative conditions, associated with loss of functionality. Falls are the leading cause of injury deaths among older adults. Furthermore, fall-related injuries among elderly accounted for more than 1.8M U.S. emergency room visits in a recent year. Direct medical costs totaled $179M for fatal and $19.3B for non-fatal fall-related injuries in the period of a year. As an effect of an ambitious non-payment for performance initiative introduced in U.S. hospitals in October 2008, Medicare will no longer pay hospitals for treatment cost of falls and related injuries that occur during the hospital stay. Hospitals will face a loss of about $50,000 for each elderly patient who falls and suffers hip fracture while in hospital care. This new quality initiative is based on the premise that falls are an avoidable medical error. In other words, falls are preventable within reason by applying evidence-based practices including medical nutrition therapy as nutritional interventions are efficacious in the prevention of falls and related injuries (e.g., fractures) among the elderly.

Chewing and swallowing difficulties are recognised risk factors for pressure ulcer development. Pressure ulcers are considered an avoidable medical error, preventable within reason by applying evidence-based practices (including nutritional care, as pressure ulcers are more likely when nutrition is inadequate). Pressure ulcers are a significant burden to the health care system. In U.S. hospitals in 2006, there were 322,946 cases of medical error connected with pressure ulcer development. The average cost of healing pressure ulcers depends on the stage, ranging from about $1,100 (for stage II) to about $10,000 (for stage III & IV pressure ulcers). Thus, the estimated cost of healing the cases of medical error connected with pressure ulcer development in one year, is in the range of $323M to $3.2B. As an effect of an ambitious non-payment for performance initiative introduced in U.S. hospitals in October 2008, Medicare will no longer pay hospitals for treatment cost of pressure ulcers that develop during the hospital stay (up to $3.2B annually). Pressure ulcers are preventable within reason, in part, by assuring nutritional intakes are adequate. Furthermore, specific interventions including the use of specialized nutritional supplements help reduce the expected time to heal pressure ulcers once they have developed.

These conditions as discussed above may result in social isolation of individuals who suffer from these conditions. Social isolation is a state of complete or near-complete lack of contact between an individual and society. It can be an issue for individuals of any age, though symptoms may differ by age group. Individuals with dysphagia often need being tube-fed and/or require PEG placement and thus may need to stay home or in-care facilities and/or hospitals for lengthy periods of time. They cannot experience the psycho-social aspects of nutritional products associated with general well-being due to lack of adequate swallowing ability, which can result in very negative psychological and/or emotional effects. These individuals may tend to have limited to no communication with family, acquaintances or friends, and/or willfully avoid any contact with other humans when those opportunities do arise because of their physical isolation and/or negative psychological and/or emotional state. Social isolation in turn can further lead to feelings of loneliness, fear of others, or negative self-esteem, which further aggravates the individuals' negative psychological and/or emotional state.

In U.S. long-term care facilities, quality of care standards are enforced via the frequent regulatory survey. Surveyors will consider facilities out of compliance when they uncover evidence of actual or potential harm/negative outcomes. The range of penalties includes fines, forced closure, as well as lawsuits and settlement fees. The Tag F325 (nutrition) survey considers significant unplanned weight change, inadequate food/fluid intake, impairment of anticipated wound-healing, failure to provide a therapeutic diet as ordered, functional decline, and fluid/electrolyte imbalance as evidence for providing sub-standard nutritional care. The Tag F314 (pressure ulcers) survey mandates that the facility must ensure that a resident who is admitted without pressure ulcers does not develop pressure ulcers unless deemed unavoidable. In addition, that a resident having pressure ulcers receives necessary treatment and services to promote healing, prevent infection and prevent new pressure ulcers from developing.

Therefore considering the prevalence of dysphagia and the possible complications related thereto, and the costs associated with same, it would be beneficial to provide nutritional products that promote safer swallowing of boluses of the nutritional products in individuals who suffer from dysphagia. Such nutritional products would improve the lives of a large and growing number of individuals who suffer from dysphagia. Specific interventions (e.g., to promote oral health, help restore normal swallowing, or reinforce a swallow-safe bolus) can enable individuals to eat orally as opposed to being tube fed and/or requiring PEG placement) and experience the psycho-social aspects of nutritional products associated with general well-being while guarding against the potentially negative consequences that result from lack of adequate swallowing ability. Improvements in the intake of nutritional products by individuals who suffer from dysphagia may also enable such individuals to swallow a wider variety of nutritional products safely and comfortably, which may lead to an overall healthier condition of the individual and prevent further health-related decline.

Existing solutions are essentially thickening agents added to any liquid to improve patient deglutition. Thickeners can be available as powder in a can or in a single-dose sachet. Thickeners can also be in a form of concentrate in a dispenser.

For example, JP6045237B2 provides tablet-type thickening agents containing thickening polysaccharide which is readily dispersible with loose stirring conditions such as hand stirring for people with lowered mastication/deglutition functions. Such a tablet-type thickening agent contains at least one thickening polysaccharide selected from the group consisting of xanthan gum, carrageenan and guar gum by 15 to 40 mass %; agar for disintegration by 15 to 40 mass %; water-soluble saccharide by 10 to 70 mass %; and metal salt by 0.2 to 10 mass %, and the hardness thereof is 15 to 70 N.

Natural bubbling or sparkling mineral waters have been popular for thousands of years. For example, ancient Greeks and Romans bathed in natural mineral springs. Carbonated beverages have been well accepted by consumers for years. The carbon dioxide (CO2) gas in the carbonated beverages ingested influences the alimentary tract through the nervous system and by direct mechanical and chemical means. The CO2 gas can modify the mouthfeel of the beverage and possibly stimulate nociceptors or taste receptors. The visual image of the bubbles in these beverages can also modify gastrointestinal (GI) perception, such as increased Ghrelin leading to more appetite, and can have the effect of nociceptive simulation. In the esophagus, the CO2 gas can decrease the lower esophageal sphincter (LES) pressure in HS. In the stomach, less than 300 mL of CO2 gas has no effect on satiety, but over 300 mL of CO2 gas can increase satiety. The CO2 gas has no effect on gastric emptying and has only slight induction of acid secretion.

Carbonation is a sensory option for dysphagia rehabilitation. It is effective through a process called chemesthesis, where the “bubbly” or “fizzy” of the carbonated beverage acts as a Trigeminal irritant, which creates a slight burning sensation. This excites lingual nociceptors via a carbonic anhydrase dependent process and in turn excites the neurons in the trigeminal subnucleus caudalis. The Trigeminal Nerve or Cranial Nerve V is one of the major swallowing nerves. The Trigeminal Nerve has bare nerve endings, which makes it more susceptible to sensory or afferent input. The carbonated beverage can actually increase the sensory stimulation for swallow. Sensory input (afferent drive) drives the motoric output (efferent drive).

Clinical studies were conducted on the effects of carbonated liquids compared to thickened liquids. For example, “Videoradiographic analysis of how carbonated thin liquids and thickened liquids affect the physiology of swallowing in subjects with aspiration on thin liquids,” Bulow et al., Acta Radiologica 44 (2003) 366-372 showed that carbonated liquids reduced penetration/aspiration into the airways, reduced pharyngeal retention and pharyngeal transit time became shorter. Therefore, carbonated liquids can be a valuable treatment option for patients with penetration/aspiration. Thickened liquids may still be an option for patients who cannot tolerate carbonated liquids, and liquids with this consistency are safer than thin liquids.

In another study described in “Effects of carbonated liquid on swallowing dysfunction in dementia with Lewy bodies and Parkinson's disease dementia,” Larsson. et al. Clinical Interventions in Aging 2017: 12 1215-1222, the researchers found that the pharyngeal transit time (PTT) for carbonated liquids (median 633 ms, interquartile range [IQR] 516-786 ms) was quicker than that for thin liquids (760 ms, IQR 613-940 ms, P=0.014) and thickened liquids (880.0 ms, IQR 600-1,500 ms, P,0.001). No significant effect was seen in residue or penetration. In those patients with a swallowing dysfunction on videofluoroscopy, 87% were found to have an improved overall swallowing function with carbonated liquids.

Clinical studies were also conducted on the effects of carbonated liquids compared to non-carbonated thin liquids. For example, in “Effects of Carbonated Liquids on Oropharyngeal Swallowing Measures in People with Neurogenic Dysphagia,” Sdravou et al., Dysphagia (2012) 27: 240-250, the researchers found that carbonated thin liquids, compared to non-carbonated thin liquids, significantly decreased penetration and aspiration on 5-ml (P=0.028) and 10-ml (P=0.037) swallows. Further, carbonated thin liquids had no significant effect on oral transit time (OTT), pharyngeal transit time (PTT), initiation of the pharyngeal swallow (IPS), and pharyngeal retention (PR) for any volume of bolus. Only one participant disliked the carbonated thin liquid stimulus.

Another such study for pediatric dysphagia is described in “Analysis of carbonated thin liquids in pediatric neurogenic dysphagia,” Lundine et al. Pediatr Radiol. 2015 August ; 45(9): 1323-1332. The researchers found that carbonated thin liquids significantly decreased pooling (P=0.0006), laryngeal penetration/aspiration (P=0.0044) and Penetration-Aspiration Scale scores (P=0.0127) when compared to non-carbonated thin liquids. On average, carbonated thin liquids improved scores on the Penetration-Aspiration Scale by 3.7 points for participants who aspirated non-carbonated thin liquids. There was no significant difference in pharyngeal residue noted between carbonated thin liquids and non-carbonated thin liquids (P=0.0625). These findings support the hypothesis that carbonated thin liquids may provide an alternative to thickened liquids for children with neurogenic dysphagia.

The traditional thickeners need to be measured and stirred in repeatedly to avoid an inconsistent drink with lumpy bits. Even with stirring and measuring, it is common to have an inconsistent drink with lumpy bits and an odd taste. The drinker is usually left with a very sweet, lumpy drink, and that defeats the object of using a carbonated drink in the first place. Further, thickeners do not improve the physiology of the swallow response.

Furthermore, research on the molecular mechanisms underlying pungent sensations revealed the existence of two cation channels, TRPV1 (transient receptor potential V1) and TRPA1 (transient receptor potential A1) that are expressed in the somatosensory fibers innervating the oral cavity. TRPV1 is the receptor for heat and burning sensations, such as capsaicin, the spicy compound of chili peppers; and isothiocyanates, the unique flavor compound of wasabi. TRPA1 responds to cold and pungent compounds; at moderate concentrations, TRPA1 agonists also exhibit a pleasant tingling sensation. Carbonated liquids have been demonstrated to be a promising format in influencing swallowing behavior by stimulating oral TRP receptors leading to the trigeminal activation of the swallowing reflex. It is primarily due to the formation of carbonic acid in the carbonated liquids that has been reported to result in a “burning and tingling—numbness” aftersensation even long after the carbonated water had been expectorated.

Oral administration of the TRPV1 agonist capsaicin has been shown to promote a swallow reflex, but capsaicin is a particularly pungent and toxic compound. Physiological effects associated with oral administration of capsaicin include a burning sensation of heat from the mid-tongue to the throat, shortness of breath, fainting, nausea, and spontaneous vomiting. As a result, only small quantities of capsaicin may be administered without causing discomfort to the individual. Food products containing capsaicin are frequently not accepted by the consumer because such products provide a very unpleasant mouth feeling. In particular, the burning effects are considered to be very unsavory, affecting the consumption of the food product.

The chemical in wasabi that provides for its initial pungency is the volatile compound allyl isothiocyanate, which is produced by hydrolysis of natural thioglucosides. The unique flavor of wasabi is a result of complex chemical mixtures from the broken cells of the plant, including those resulting from the hydrolysis of thioglucosides from sinigrin into glucose and methylthioalkyl isothiocyanates. The burning sensations of wasabi are short-lived compared to the effects of capsaicin in chili peppers and are washed away with more food or liquid. The sensation is felt primarily in the nasal passage and can be quite painful depending on the amount consumed.

### SUMMARY

The present disclosure relates to an effervescent or fizzy composition and the use thereof to provide trigeminal sensory stimulation at a dosage and a viscosity effective to improve the swallowing function of a patient suffering from dysphagia. The present disclosure provides people suffering from dysphagia with a novel type of solution combining a thickening agent and optionally a trigeminal ingredient at the effective concentrations, with a pre-dosed effervescent composition that can be dissolved in a diluent or a liquid, such as water, and provide a nutritional product or a ready-to-drink (RTD) beverage suitable for people suffering from dysphagia

The present disclosure is related to an effervescent composition or an easy and/or fast dissolving thickener composition formulated for dissolving into a nutritional product, a use of the composition, a method for making a nutritional product from the composition, a nutritional product made from the composition, a ready-to-drink (RTD) beverage, and a related system.

In a first aspect, the present disclosure provides an effervescent composition or an easy and/or fast dissolving thickener composition formulated for dissolving into a nutritional product suitable for administration to an individual having dysphagia, the composition comprising an acid compound, an alkaline compound, a thickening agent, and optionally a trigeminal ingredient.

The composition can be any suitable format, such as a powder, a tablet, a powder in soluble packaging, bricks, a liquid or gel in suitable packaging.

The acid compound can be selected from the group consisting of, but not limited to citric acid, ascorbic acid, nicotinic acid, acetylsalicylic acid, succinic acid, adipic acid, tartaric acid, fumaric acid, adipic acid, malic acid, anhydrides, salts thereof, and combinations thereof.

The alkaline compound can be selected from the group consisting of, but not limited to potassium carbonate, sodium carbonate, sodium bicarbonate, potassium bicarbonate, sodium glycine carbonate, calcium carbonate, arginine carbonate, potassium bitartrate, sodium tartrate, and combinations thereof.

The trigeminal ingredient can be selected from the group consisting of, but not limited to, cinnamaldehyde with or without zinc, p-anisaldehyde, cumminaldehyde, tiglic aldehyde, Sichuan pepper, capsaicin, capsiate, isothiocyanate, and combinations thereof.

The thickening agent may comprise a gum and/or a starch. The gum may comprise at least one of xanthan gum, gum arabic, carrageenan (lambda), carrageenan (iota), carrageenan (kappa), sodium alginate, konjac, locust bean gum, carboxymethyl cellulose (CMC), chitosan, inulin, pectin (from citrus), pectin (from apple), hydroxypropyl methylcellulose (HPMC), or tara gum.

The composition may further comprise at least one of a protein, a fat, a fiber, a carbohydrate, a prebiotic, a probiotic, an amino acid, a fatty acid, a phytonutrient, an antioxidant, an electrolyte, or a vitamin.

The nutritional product may be in an administrable form selected from the group consisting of a pharmaceutical formulation, a medical food, a nutritional formulation, a dietary supplement, a functional food and beverage product, and a ready-to-drink (RTD) beverage.

In another aspect, the present disclosure provides a method of making a nutritional product, the method comprising providing the effervescent composition; dissolving the effervescent composition in a liquid to provide the nutritional product. The thickening agent can provide to the nutritional product a relaxation time, determined by a Capillary Breakup Extensional Rheometry (CaBER) experiment, of more than 10 ms at 20° C. and/or a shear viscosity up to about 2,000 mPas measured at a shear rate of 50 s-1 at 20° C. The nutritional product is suitable for administration to an individual having dysphagia.

In another aspect, the present disclosure provides a ready-to-drink (RTD) beverage formulated for administration to an individual having dysphagia. The ready-to-drink (RTD) beverage can have a relaxation time, determined by a Capillary Breakup Extensional Rheometry (CaBER) experiment, of more than 10 ms at 20° C. and/or a shear viscosity up to about 2,000 mPas measured at a shear rate of 50 s-1 at 20° C. The ready-to-drink (RTD) beverage can include at least one ingredient selected from the group consisting of proteins, vitamins, and minerals. The ready-to-drink (RTD) beverage can be fat free.

In a further aspect, the effervescent composition, the nutritional product made from the effervescent composition, and/or the ready-to-drink (RTD) beverage can be used for preventing, alleviating, and/or compensating swallowing dysfunction in a patient in need thereof.

In a further aspect, the effervescent composition, the nutritional product made from the effervescent composition, and/or the ready-to-drink (RTD) beverage can be used for promoting swallowing safety and/or efficiency in a patient in need thereof.

In a further aspect, the effervescent composition, the nutritional product made from the effervescent composition, and/or the ready-to-drink (RTD) beverage can be used for mitigating a risk of aspiration during swallowing in a patient in need thereof.

In another aspect, the present disclosure provides use of the effervescent composition and a liquid in preparation of an orally administrable nutritional product, the liquid is suitable for consumption by an individual without dysphagia, (optionally not suitable for an individual having dysphagia,) and the orally administrable nutritional product is suitable for administration to an individual having dysphagia.

In another aspect, the present disclosure provides a system for production of a homogenous single-phase beverage for administration to an individual having dysphagia, the system comprising: a container containing the effervescent composition formulated for dilution into the homogenous single-phase beverage; and a metering device connected to the container and configured to dispense a predetermined amount of the effervescent composition.

An advantage of one or more embodiments provided by the present disclosure is promoting both safer and more effective swallowing of boluses of a palatable nutritional product in an individual suffering from dysphagia.

An advantage of one or more embodiments provided by the present disclosure is increasing the sensory stimulation for the swallow of an individual suffering from dysphagia. Sensory input (afferent drive) drives the motoric output (efferent drive).

An advantage of one or more embodiments provided by the present disclosure is providing the dual benefit of ease of swallowing and nutrient-dense recipes fortified with nutrients, such as protein and essential nutrients, in one serve for an individual suffering from dysphagia.

An advantage of one or more embodiments provided by the present disclosure is providing a variety of flavors and thus help minimizing taste fatigue of nutritional products for an individual suffering from dysphagia.

An advantage of one or more embodiments provided by the present disclosure is providing better hydration, compliance, and discrete usage on the move and meeting a variety of flavor preferences of an individual suffering from dysphagia.

An advantage of one or more embodiments provided by the present disclosure is providing nutritional products that can be easily dissolved into water or a liquid of the individual's choice, without the need to stir or with minimal stir, as well as an “auto-thickening” effect provided by the effervescence, to provide consistent, well mixed and ready to drink nutritional products for an individual suffering from dysphagia. It leads to higher ease of use because of the convenience and thus higher compliance.

An advantage of one or more embodiments provided by the present disclosure is providing a thickened liquid in improving the swallowing reflex leading to better hydration and compliance of an individual suffering from dysphagia.

An advantage of one or more embodiments provided by the present disclosure is to provide a positive visual cue, which is important for compliance and motivates diagnosed dysphagia patients to follow the prescribed intervention, and also appealing to younger patients such as kids.

An advantage of one or more embodiments provided by the present disclosure is to improve the lives of a large and growing number of individuals who suffer from dysphagia.

Another advantage of one or more embodiments provided by the present disclosure is to support specific interventions (e.g., to promote oral health, help restore normal swallowing, or reinforce a swallow-safe bolus) that can enable individuals to eat orally instead of being tube fed and/or requiring PEG placement and experience the psycho-social aspects of nutritional products associated with general well-being while guarding against the potentially negative consequences that result from lack of adequate swallowing ability, and therefore, prevent social isolation.

Yet another advantage of one or more embodiments provided by the present disclosure is to improve the intake of nutritional products by individuals who suffer from dysphagia and thus enable such individuals to swallow a wider variety of nutritional products safely, comfortably, and pleasantly, which may lead to an overall healthier condition of the individual and prevent further health-related decline.

Moreover, another advantage of one or more embodiments provided by the present disclosure is to modify rheological properties of a nutritional product to prevent bolus penetration and aspiration and/or reduction of residues if the thickener is xanthan based.

Still another advantage of one or more embodiments provided by the present disclosure is a nutritional product having organoleptic properties superior to known thickened nutritional products.

Moreover, another advantage of one or more embodiments provided by the present disclosure is reduction of swallowing effort for individuals who suffer from dysphagia.

Yet another advantage of one or more embodiments provided by the present disclosure is improved nutritional intake for individuals who suffer from dysphagia by enabling the individuals to swallow a wider variety of food and beverage products safely and comfortably without intolerable flavor/taste and/or mouth feeling and thus lending confidence to the individuals who suffer from dysphagia that the individual is able to consume a wider range of products pleasantly.

Still another advantage of one or more embodiments provided by the present disclosure is improved ability and efficiency to swallow and thus improved safety through reduced risk of pulmonary aspiration and/or reduction of residues if the thickener is xanthan based.

Furthermore, another advantage of one or more embodiments provided by the present disclosure is greater independence from feeding assistance and/or reduced length of time spent in feeding-assistance during meal consumption.

Additional features and advantages are described herein and will be apparent from the following Detailed Description.

### DETAILED DESCRIPTION

The various aspects and embodiments according to the present disclosure, as set forth herein, are illustrative of the specific ways to make and use the invention and do not limit the scope of invention when taken into consideration with the claims and the detailed description. It will also be appreciated that features from aspects and embodiments of the invention may be combined with further features from the same or different aspects and embodiments of the invention.

As used in this detailed description and the appended claims, the singular forms “a,” “an” and “the” include plural referents unless the context clearly dictates otherwise. For example, reference to “an ingredient” or “a method” includes a plurality of such “ingredients” or “methods.” The term “and/or” used in the context of “X and/or Y” should be interpreted as “X,” or “Y,” or “X and Y.” Similarly, “at least one of X or Y” should be interpreted as “X,” or “Y,” or “both X and Y.” Similarly, the words “comprise,” “comprises,” and “comprising” are to be interpreted inclusively rather than exclusively. Likewise, the terms “include,” “including” and “or” should all be construed to be inclusive, unless such a construction is clearly prohibited from the context. However, the embodiments provided by the present disclosure may lack any element that is not specifically disclosed herein. Thus, a disclosure of an embodiment defined using the term “comprising” is also a disclosure of embodiments “consisting essentially of” and “consisting of” the disclosed components. “Consisting essentially of” means that the embodiment or component thereof comprises more than 50 wt. % of the individually identified components, preferably at least 75 wt. % of the individually identified components, more preferably at least 85 wt. % of the individually identified components, most preferably at least 95 wt. % of the individually identified components, for example at least 99 wt. % of the individually identified components.

All ranges described are intended to include all numbers, whole or fractions, contained within the said range. As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth. As used herein, wt. % refers to the weight of a particular component relative to total weight of the referenced composition. The ranges described herein include all variations between the two end points.

The relative terms “promote,” “improve,” “increase,” “enhance” and the like refer to the effects of the effervescent composition and/or the nutritional product made from the effervescent composition and/or the nutritional RTD beverage disclosed herein relative to a product not made from the effervescent composition, but otherwise identical.

In one aspect, the present disclosure provides an effervescent composition comprising an acidic compound, an alkaline compound, optionally a thickening agent and optionally a trigeminal ingredient. The effervescent composition is formulated for dilution in an appropriate amount of a diluent, such as water, to provide a nutritional product with a viscosity suitable for an individual having dysphagia and an optimum combination of trigeminal sensation from presence of carbonic acid and optionally a trigeminal ingredient.

As used herein, an “effervescent” composition means a composition that can dissolve in a diluent (e.g., a liquid, water, or like) while releasing carbon dioxide simultaneously. When dissolved in the diluent, the effervescent composition gives rise to effervescence, i.e., fizz by releasing carbon dioxide from the solution as small bubbles, which causes the solution to become effervescent or fizzy. The carbon dioxide is produced from the reaction between the acidic compound and the alkaline compound once they are dissolved in the diluent.

The acidic compound may comprise at least one edible acid, such as citric acid, tartaric acid, ascorbic acid, nicotinic acid, acetylsalicylic acid, succinic acid, adipic acid, fumaric acid, adipic acid, and/or malic acid; and/or at least one acid anhydride, such as glutaric anhydride, succinic anhydride, etc.; and/or at least one acid salt, such as amino acid hydrochlorides, sodium dihydrogen phosphate, acid citrate salts, etc.

The alkaline compound may comprise at least one of a carbonate or a tartrate. The carbonate may be any suitable carbonate salt, such as potassium carbonate, sodium carbonate, sodium bicarbonate, potassium bicarbonate, sodium glycine carbonate, calcium carbonate, or arginine carbonate. Sodium bicarbonate is a preferred carbonate because of high solubility, severe reaction and low cost. The tartrate can be any suitable tartrate salt, such as potassium bitartrate or sodium tartrate.

The ratio between the alkaline compound versus the acidic compound is known in the art. In a preferred embodiment, it is such that three molecules of sodium bicarbonate are required to neutralize one molecule of citric acid, resulting in the liberation of carbon dioxide. For example, the composition may comprise about 1.3 g citric acid anhydrous (Sigma-Aldrich GmbH, Germany) and about 4 g sodium bicarbonate powder (Sigma-Aldrich).

After the reaction of the acidic component and the alkaline component is completed, the resultant liquid product may no longer be sparkling. Sparkling can be enhanced in the liquid product, for example, by encapsulation of the carbonic acid or N₂ injection in order to obtain a slow-release fizziness. Additional carbon dioxide can also be added into the liquid product to produce a carbonated liquid product.

In addition, as the liquid product starts to thicken up, the level of viscosity will have an impact on the ability of the thickened drink to retain the bubbles. That is, a high level viscosity (pudding) will be more likely to retain bubbles than a low level (nectar).

A portion of the carbon dioxide in the liquid product, sparkling/carbonated or not, may mix with the water to forms carbonic acid. When the liquid product is consumed, the carbon dioxide also reacts with the carbonic anhydrase in saliva to subsequently produce the carbonic acid. The carbonic acid creates a tingling sensation on the tongue, which can be pleasant. The consumed carbonic acid also releases carbon dioxide in the consumer's body, and the carbon dioxide diffuses in cells, which produces acidification at the intracellular level, thus activating TRP 1 channels.

It is hypothesized that the fizzy and tingling perception of carbonated beverages is likely to be due to a multimodal sensation comprising gustatory as well as somatosensory inputs. The fizzy sensation perceived by humans upon consumption of carbonated beverages is mediated by carbonic anhydrase IV in saliva, which creates the carbonic acid.

The trigeminal ingredient can also create a tingling sensation that is pleasant. The pleasant tingling sensation can promote the swallowing reflex. Promotion of the swallowing reflex can include, for example, provoking a swallowing reflex, increasing the ability of the individual to swallow, increasing the efficacy of the swallow, decreasing a delay in swallowing, and combinations thereof.

The trigeminal ingredient may comprise at least one of cinnamaldehyde, p-anisaldehyde, cumminaldehyde, tiglic aldehyde, Sichuan pepper, capsaicin, capsiate, isothiocyanate, other TRPV1 and TRPA1 receptor agonists, or derivatives thereof. Cinnamaldehyde can be used with or without zinc.

The trigeminal ingredient may comprise an isothiocyanate, such as allyl isothiocyanate, 6-(Methylsulfinyl)hexyl isothiocyanate (6-MITC or 6-MSITC), 7-methylthioheptyl isothiocyanate, and/or 8-methylthiooctyl isothiocyanate. Allyl isothiocyanate is a pungent component of wasabi. The unique flavor of wasabi is a result of complex chemical mixtures of 6-(Methylsulfinyl)hexyl isothiocyanate (6-MITC or 6-MSITC), 7-methylthioheptyl isothiocyanate, and 8-methylthiooctyl isothiocyanate.

The trigeminal ingredient may comprise capsaicin, capsaicin derivatives, and capsinoid compounds. Examples of capsaicin derivatives include N-vanillyl-alkanedienamide, N-vanillyl-alkanedienyl, N-vanillyl-cis-monounsaturated alkanamide, dihydrocapsaicin, norhydrocapsaicin, norhydrocapsaicin, homocapsaicin, and dihydrocapsaicin. Capsinoid compounds are fatty acid esters of vanillyl alcohol, and typical examples include capsiates, such as capsiate, dihydrocapsiate, nordihydrocapsiate, vanillyl decanoate, vanillyl nonanoate, and vanillyl octanoate. In addition, fatty acid esters of various linear or branched fatty acids and vanillyl alcohol having fatty acid chain length comparable to nordihydrocapsiate can be included, but not limited thereto.

The trigeminal ingredient may comprise cinnamaldehyde and zinc. The combination provides a minimal flavor impact and is effective to promote a swallowing reflex. Cinnamaldehyde and zinc have a synergy on the pharmacological activity of TRPA1. Using this synergy, the effective amount of cinnamaldehyde can be decreased by supplementing the cinnamaldehyde with small amount of zinc. Consequently, the combination of cinnamaldehyde and zinc can promote a swallowing reflex at concentrations in food that are tolerable both in flavor/taste and in the gastrointestinal tract. Moreover, the synergy only requires a low concentration of zinc (in vitro<1 μM). Accordingly, the trigeminal ingredient can comprise an amount of the cinnamaldehyde that is orally tolerable, for example does not cause an unpleasant mouth feeling, and, in combination with the zinc, effective to promote a swallowing reflex.

The cinnamaldehyde in the effervescent composition can be provided in a cinnamon essential oil extract, for example an extract from steam distillation of the oil of cinnamon bark; can be isolated cinnamaldehyde, for example isolated from cinnamon essential oil; or can be synthesized cinnamaldehyde, for example the product of aldol condensation of benzaldehyde and acetaldehyde. The concentration of cinnamaldehyde in the effervescent composition is preferably at flavoring concentration from 31.87 ppm (condiments, relishes) up to 6191 ppm (chewing gum) (Fenaroli's Handbook; Burdock, 2010). In an embodiment, the cinnamaldehyde is present in effervescent composition in an amount of about 100 ppm or less; 100 pm is equivalent to about 756 μM, the flavoring range in gelatins according to Fenaroli's Handbook (Burdock, 2010).

Preferred forms of zinc include zinc chloride, zinc sulfate, zinc lactate and zinc citrate. The cinnamaldehyde:zinc ratio is preferably 1:0.5 to 1:0.005, more preferably 1:0.03 (in molarity).

Other TRPV1 agonists can include compounds lacking vanillyl function such as piperine, dialdehyde sesquiterpene (for example, wobble ganal, polygodial or isoberellal), scutigeral, triprenylphenol and the like.

The thickening agent may comprise at least one of a starch or a gum, such as xanthan gum. The thickening agent may comprise a plant-extracted gum selected from the group consisting of okra gum, konjac mannan, tara gum, locust bean gum, guar gum, fenugreek gum, tamarind gum, cassia gum, acacia gum, gum ghatti, pectins, cellulosics, tragacanth gum, karaya gum, and combinations thereof; and/or a plant-derived mucilages selected from the group consisting of cactus mucilage, psyllium mucilage, mallow mucilage, flax seed mucilage, marshmallow mucilage, ribwort mucilage, mullein mucilage, cetraria mucilage, and combinations thereof. In some embodiments, the thickening agent may comprise at least one of gum arabic, carrageenan (lambda), carrageenan (iota), carrageenan (kappa), sodium alginate, konjac, locust bean gum, carboxymethyl cellulose (CMC), chitosan, inulin, pectin (from citrus), pectin (from apple), hydroxypropyl methylcellulose (HPMC), tara gum, or combinations thereof.

The effervescent composition can be a powder. As used herein, a “powder” is a solid that is formulated to be diluted before administration. Further in this regard, the powders disclosed herein are only administered after addition of another ingredient, such as a liquid diluent, preferably water.

The effervescent composition can be a tablet. The effervescent tablet may also comprise a binder, such as polyvinylpyrolidone (PVP) or any other suitable binder. The binder is preferably water-soluble. It can be added as dry powder or in a wet form as an aqueous or hydroalcoholic solution. Mannitol, PEG 6000 and water in small amounts can also be used as a binder. PEG 6000 at 3% use level can be used as a dry binder. The ideal amount of binder is one that makes the tablet hard enough to handle but soft enough to disintegrate and dry enough to be stable. The effervescent tablet may also be formulated without a binder.

The effervescent composition can be any other suitable format such a powder in soluble packaging, bricks, liquid or gel in suitable packaging.

Other ingredients such as disintegrants, lubricants and food materials may be included. Examples of disintegrants include croscarmellose sodium, carmellose calcium, carmellose, celluloses such as low-substituted hydroxypropyl cellulose, carboxymethyl starch sodium, carboxymethyl starch, hydroxypropyl starch, pregelatinized starch, and partially pregelatinized starch and the like, crospovidone, carboxymethylcellulose calcium, carboxymethylcellulose sodium and the like. Examples of lubricants include magnesium stearate, calcium stearate, talc, sucrose fatty acid ester, stearic acid, aluminum stearate, potassium sodium tartrate, light anhydrous silicic acid, carnauba wax, carmellose calcium, carmellose sodium, hydrous dioxide Examples thereof include silicon and hydrogenated oil.

Surfactants may also be added to increase wettability. In some cases, antifoaming agents (e.g. polydimethylsiloxane) may be included in the formulation to reduce foam formation and thus reduce the tendency of ingredients of the composition to stick to the wall of the glass above the water level.

The effervescent tablets can be produced and controlled same as conventional tablets. These controls include physicochemical properties such as hardness, weight variation, friability, solution time, pH and content uniformity. The effervescent tablets can be produced by a direct compression method, a fusion method, a wet or dry granulation method, or any other suitable method. Low relative humidity (e.g., maximum of 25% or less) and moderate to cool temperatures (e.g., about 25° C. or 77° F.) in the environment may be essential to prevent sticking granule or tablets to the tablet press machine.

In the direct compression method, the effervescent tablet can be formed by compressing the ingredients in the form of powders into a dense mass, for example, by a tablet press machine. The powdered ingredients may be first granulized to similar or equal sizes before being made into tablets, so that the mixtures of powder have excellent flowability without particles segregation. Granulating may not be required if the raw materials are selected to achieve a free-flowing, non-segregating, compressible powder blend. The tablets can then be dried by heat, such as in an oven with air circulation, at a suitable temperature for a suitable time and after cooling can be packed in a suitable package.

In the fusion method, the ingredients can be mixed in a suitable mixer, such as a blender, for an appropriate time. Then, the obtained mixture can be heated to a suitable temperature. The powder may be mixed regularly until the crystallization water of citric acid is released as binder factor (e.g., approximately 30 minutes) and an appropriate pasty mass is obtained. This wet mass can be passed through a sieve to obtain the desired granules, which can then be dried at a suitable temperature for an appropriate time. After drying, the granules can be passed through the sieve again. Other ingredients can be added to the granule mass and mixed for a suitable time. The granule mixtures then can be compressed into tablets by the tablet press machine. Finally, the tablets can be dried and packed in a suitable package.

In the wet granulation method, the ingredients may be milled by a miller, either separately or as a mixture with ethanol, ethanol-water mixture, isopropanol, etc., and the obtained powder can be passed through a sieve and then blended. A binder solution can be added to the mixture to form a pasty mass. This pasty mass can then be passed through a sieve to obtain desired granules, which can then dried. The dried mass can be passed through a sieve again, and other ingredients can be added and mixed. The obtained granule mixtures then can be compressed into tablets by the tablet press machine. Finally, the tablets can be dried and packed in a suitable package. Wet granulation can also be performed by carefully adding 0.1 to 1.0 per cent water (weight-to-weight basis) to a blend of raw materials that possess the uniformity, compressibility, and flowability needed to produce good-quality tablets, but which lacks the needed binding properties. The free water which is usually added in the form of a fine spray to selected formulation components while mixing in a suitable blender acts as a binder. The granulation steps must be precisely timed and the ingredients mixed thoroughly to distribute the granulating fluid evenly in the blend. The mix is then quickly discharged to drying ovens. After drying, the granules are sized, and a final mix is performed. The granules are then compressed into tablets using tablet machines.

The dry granulation method can use special processing equipment known as a “roller compactor” or “chilsonator.” These machines compress premixed powders between two counterrotating rollers under extreme pressure. Depending on the configuration of the roller, the feed material may be compacted into dense ribbon-like materials known as flakes (smooth rolls) or dense briquettes (almond or stick-shaped) if the rollers have grooved or etched surfaces. The compressed material is reduced to the proper size for tablet granulation purposes. Another dry granulation procedure is slugging, in which the powder particles are compressed into large flat tablets or pellets using a tablet press or more usually, a heavy-duty tablet-compacting equipment. The resulting tablet or slug are milled to yield the desired granule characteristics.

The effervescent tablet can be made in any shape and can have any suitable size. As non-limiting examples, the tablet can be 5 mm to 20 mm long, thick, and/or in diameter if having a round shape. The size of the tablet can be from 5 mm to 10 mm, 5 mm to 15 mm, 10 mm to 15 mm, 10 mm to 20 mm, or 15 mm to 20 mm.

The effervescent composition can comprise an amount of the thickening agent that may provide to a nutritional product into which the effervescent composition is dissolved a relaxation time, determined by a Capillary Breakup Extensional Rheometry (CaBER) experiment, of more than 10 ms, preferably more than 50 ms, such as from 50 ms to 450 ms, more preferably more than 100 ms, such as from 100 ms to 450 ms, more preferably more than 400 ms, such as from 400 ms to 450 ms, more preferably about 200 ms, at a temperature of 20° C. The amount of the thickening agent may provide to the nutritional product a shear viscosity up to about 2,000 mPas, preferably up to about 500 mPas, more preferably up to about 200 mPas, most preferably up to about 50 mPas, all values measured at a shear rate of 50 s⁻¹ at 20° C.

It is appreciated that measurement of shear viscosity can be performed at a different shear rate, for example another shear rate from 0 to 100 s⁻¹, or at different temperature, for example another temperature from 0 to 100° C.; nevertheless, such measurements must be related back to the standard conditions of 50 s⁻¹ at 20° C. disclosed herein.

A shear flow is a flow of a solution in which parallel planes are displaced in a direction parallel to each other. Shear viscosity is a measurable rheological property. Shear viscosity, often referred to as viscosity, describes the action of a material to applied shear stress. In other words, shear stress is the ratio between “stress” (force per unit area) exerted on the surface of a fluid, in the lateral or horizontal direction, to the change in velocity of the fluid as you move down in the fluid (a “velocity gradient”). Shear viscosity of a nutritional product can be determined by any method that can accurately control the shear rate applied to the product and simultaneously determine the shear stress or vice versa. Often used are rheometers which generally impose a specific stress field or deformation to the fluid and monitor the resultant deformation or stress. These instruments may operate in steady flow or oscillatory flow, as well as shear. Standard methods include the use of concentric cylinders, cone-and-plate and plate-plate geometries.

Another rheological property of a material is its extensional viscosity. An extensional flow is the behavior of a solution to resist extension and return to a coil structure while being squeezed or pulled. Extensional viscosity is the ratio of the stress required to extend a liquid in its flow direction to the extension rate. Extensional viscosity coefficients are widely used for characterising polymers, where they cannot be simply calculated or estimated from the shear viscosity.

Extensional viscosity is often measured by the relaxation time determined using the Capillary Breakup Extensional Rheometer (CaBER), which is an example for a rheometer applying extensional stress. During the CaBER experiment as performed herein for measuring the relaxation time of the nutritional product, a drop of said product is placed between two vertically aligned and parallel circular metal surfaces, both having a diameter of 6 mm. The metal surfaces are then rapidly separated linearly over a time interval of 50 ms. The filament formed by this stretching action subsequently thins under the action of interfacial tension and the thinning process is followed quantitatively using a digital camera and/or laser sheet measuring the filament diameter at its mid-point. The relaxation time in a CaBER experiment is determined by plotting the normalised natural logarithm of the filament diameter during the thinning process versus time and determining the slope of the linear portion (dₗₙ(D/D₀)/dₜ) of this curve, where D is the filament diameter, Do the filament diameter at time zero and t the time of filament thinning. The relaxation time in this context is then defined as minus one third (−⅓) times the inverse of this slope, i.e. −1/(3 dₗₙ(D/D₀)/dₜ).

The cohesion or cohesiveness of a nutritional composition or a bolus thereof is the ability of the nutritional composition or the bolus thereof to bind and stay together in the oral cavity and through the swallowing process. It may be measured by the “stringiness” of the nutritional composition or the bolus thereof, which is a proxy of and directly related to the relaxation time.

It is preferred that in the present nutritional product, the relaxation time is from 10 ms to 2000 ms, preferably from 20 ms to 1000 ms, likewise preferably from 50 ms to 450 ms, from 100 ms to 2000 ms, from 100 ms to 450 ms, and more preferably from 200 ms to 2000 ms, from 200 ms to 450 ms, or about 200 ms, each at a temperature of 20° C.

Moreover, in some embodiments, a filament diameter of the nutritional product decreases less than linearly, and preferably exponentially in time during the CaBER experiment. The filament diameter can be measured using a digital camera and/or laser sheet measuring device.

As used herein, the feature “bolus” includes any entity of the nutritional product formed in the mouth in preparation for swallowing. The bolus may be of any shape, size, composition and/or texture, and thus it may also be a liquid.

As used herein, the term “nutritional product” refers to a nutritional composition for oral administration by an individual who suffers from dysphagia. The nutritional product is envisaged for supplemental nutrition, for hydration, or for replacement of one or more full meals of the individual who suffers from dysphagia. The present disclosure is not limited to a specific embodiment of the nutritional product.

Furthermore, the present disclosure is not limited to a specific embodiment of the diluent in which the effervescent composition is dissolved, and the diluent can be any liquid suitable for consumption by an animal or human.

The term individual refers to any human, animal, mammal or who suffers from dysphagia that can benefit from the nutritional product. It is to be appreciated that animal includes, but is not limited to, mammals. Mammal includes, but is not limited to, rodents, aquatic mammals, domestic animals such as dogs and cats, farm animals such as sheep, pigs, cows and horses, and humans.

In some embodiments, the diluent can be one or more of water, milk, a beverage comprising water and further comprising at least one component additional to the water, a liquid oral nutritional supplement (ONS), or a food product.

The dilution of the effervescent composition in the diluent can directly form the nutritional product such that the nutritional product consists essentially of or consists of the diluent and the effervescent composition.

In some embodiments, the dilution of the effervescent composition in the diluent forms an aqueous solution followed by addition of the aqueous solution to at least one other orally administrable composition to form the nutritional product, such that the nutritional product consists essentially of or consists of the diluent, the effervescent composition, and the at least one other orally administrable composition. In some embodiments, the nutritional product can be a ready-to-drink (RTD) beverage.

The effervescent composition can be dissolved in the diluent to form the nutritional product without the need to stir or with minimal stir, even when a thickening agent is included in the effervescent composition.

In some embodiments, the nutritional product is in a unit dosage form comprising an effective amount of the thickening component for administration of the nutritional product to an individual who suffers from dysphagia to achieve at least one of (i) supplemental nutrition, (ii) hydration and (ii) replacement of one or more full meals.

As used herein, an “effective amount” is an amount that prevents a deficiency, treats a disease or medical condition in an individual or, more generally, reduces symptoms, manages progression of the diseases or provides a nutritional, physiological, or medical benefit to the individual.

A “ready-to-drink” beverage or “RTD” beverage is a beverage in liquid form that can be consumed without further addition of liquid. Preferably an RTD beverage is aseptic. An “oral nutrition supplement” or “ONS” is a composition comprising at least one macronutrient and/or at least one micro nutrient, for example in a form of sterile liquids, semi-solids or powders, and intended to supplement other nutritional intake such as that from food. It can also be formulated as sole source of nutrition. Non-limiting examples of commercially available ONS products include, for example, MERITENE®, BOOST®, NUTREN® SUSTAGEN®, RESOURCE®, and CLINUTREN®. The term “unit dosage form,” as used herein, refers to physically discrete units suitable as unitary dosages for human and animal subjects, each unit containing a predetermined quantity of the composition disclosed herein in an amount sufficient to produce the desired effect, preferably in association with a pharmaceutically acceptable diluent, carrier or vehicle. The specifications for the unit dosage form depend on the particular compounds employed, the effect to be achieved, and the pharmacodynamics associated with each compound in the host. In an embodiment, the unit dosage form can be a predetermined amount of liquid concentrate dispensed by a dispenser or housed within a container such as a pouch.

In one aspect, the present disclosure provides a nutritional RTD beverage. The nutritional RTD beverage can have the same composition and/or properties as the nutritional product made from the effervescent composition. The nutritional RTD beverage can be a nutritional RTD beverage suitable for an individual suffering from dysphagia but with carbonation. In some embodiments, the nutritional RTD beverage can be a fat-free, refreshing fruit-flavored nutrition drink. The nutritional RTD beverage is easy to swallow and fills the nutritional gaps for an individual suffering from dysphagia. The nutritional RTD beverage can be sparkling or carbonated. The nutritional RTD beverage may also be non-sparkling/carbonated, but include carbonic acid in an amount effective to bring a tingling sensation and/or produce acidification at the intracellular level, thus activating TRP 1 channels, which promotes swallow reflex.

The nutritional product may also include any number of optional ingredients (e.g., ingredients additional to the effervescent composition from which the nutritional product is made). Non-limiting examples of suitable optional ingredients include conventional food additives, for example one or more, acidulants, additional thickeners, buffers or agents for pH adjustment, chelating agents, electrolytes, colorants, emulsifiers, excipient, flavour agent, minerals, osmotic agents, a pharmaceutically acceptable carrier, preservatives, stabilisers, sugar(s), sweetener(s), texturiser(s), and/or vitamin(s). The nutritional RTD beverage can also include any number of these ingredients. The optional ingredients can be added in any suitable amount.

The effervescent composition, the nutritional product made from the effervescent composition, and/or the nutritional RTD beverage may further comprise one or more of a protein, a fat, a fiber, a carbohydrate, a prebiotic, a probiotic, an amino acid, a fatty acid, a phytonutrient, an antioxidant, an electrolyte, and a vitamin, and/or combinations thereof.

The protein can be a dairy-based protein, a plant-based protein or an animal-based protein or any combination thereof. Dairy-based proteins include, for example, casein, caseinates (e.g., all forms including sodium, calcium, potassium caseinates), casein hydrolysates, whey (e.g., all forms including concentrate, isolate, demineralized), whey hydrolysates, milk protein concentrate, and milk protein isolate. Plant-based proteins include, for example, soy protein (e.g., all forms including concentrate and isolate), pea protein (e.g., all forms including concentrate and isolate), canola protein (e.g., all forms including concentrate and isolate), other plant proteins that commercially are wheat and fractionated wheat proteins, corn and it fractions including zein, rice, oat, potato, peanut, green pea powder, green bean powder, and any proteins derived from beans, lentils, and pulses. Animal-based proteins may be selected from the group consisting of beef, poultry, fish, lamb, seafood, or combinations thereof. Preferably, the protein is at least one of rice protein or lentil protein.

The fat can be vegetable fat (such as olive oil, corn oil, sunflower oil, rapeseed oil, hazelnut oil, soy oil, palm oil, coconut oil, canola oil, lecithins, and the like), animal fat (such as milk fat) or any combinations thereof.

The fiber can be a fiber blend that may contain a mixture of soluble and insoluble fiber. Soluble fibers may include, for example, fructooligosaccharides, acacia gum, inulin, and the like. Insoluble fibers may include, for example, pea outer fiber.

The carbohydrate can comprise sucrose, lactose, glucose, fructose, corn syrup solids, maltodextrin, modified starch, amylose starch, tapioca starch, corn starch or any combinations thereof.

The effervescent composition, the nutritional product made from the effervescent composition, and/or the nutritional RTD beverage can comprise at least one the following prebiotics or any combination thereof: acacia gum, alpha glucan, arabinogalactans, dextrans, fructooligosaccharides, fucosyllactose, galactooligosaccharides, galactomannans, gentiooligosaccharides, glucooligosaccharides, guar gum, inulin, isomalto-oligosaccharides, lactoneotetraose, lactosucrose, lactulose, levan, maltodextrins, milk oligosaccharides, partially hydrolyzed guar gum, pecticoligosaccharides, resistant starches, retrograded starch, sialooligosaccharides, sialyllactose, soyoligosaccharides, sugar alcohols, xylooligosaccharides, or their hydrolysates, or combinations thereof. The prebiotic is a food substance that selectively promotes the growth of beneficial bacteria or inhibits the growth or mucosal adhesion of pathogenic bacteria in the intestines. The prebiotic is not inactivated in the stomach and/or upper intestine or absorbed in the gastrointestinal tract of the individual ingesting them, but they are fermented by the gastrointestinal microflora and/or by probiotics. Prebiotics are, for example, defined by Glenn R. Gibson and Marcel B. Roberfroid, Dietary Modulation of the Human Colonic Microbiota: Introducing the Concept of Prebiotics, J. Nutr. 1995 125: 1401-1412.

The effervescent composition, the nutritional product made from the effervescent composition, and/or the nutritional RTD beverage can comprise at least one probiotic. Probiotics are food-grade microorganisms (alive, including semi-viable or weakened, and/or non-replicating), metabolites, microbial cell preparations or components of microbial cells that could confer health benefits on a host when administered, more specifically probiotics beneficially affect the host by improving intestinal microbial balance, leading to effects on the health or well-being of the host. See, Salminen S, Ouwehand A. Benno Y. et al., Probiotics: how should they be defined?, Trends Food Sci. Technol. 1999:10, 107-10. In general, it is believed that these probiotics inhibit or influence the growth and/or metabolism of pathogenic bacteria in the intestinal tract. The probiotics may also activate the immune function of the host. The probiotics may include Aerococcus, Aspergillus, Bacillus, Bacteroides, Bifidobacterium, Candida, Clostridium, Debaromyces, Enterococcus, Fusobacterium, Lactobacillus, Lactococcus, Leuconostoc, Melissococcus, Micrococcus, Mucor, Oenococcus, Pediococcus, Penicillium, Peptostrepococcus, Pichia, Propionibacterium, Pseudocatenulatum, Rhizopus, Saccharomyces, Staphylococcus, Streptococcus, Torulopsis, Weissella, or any combination thereof.

The effervescent composition, the nutritional product made from the effervescent composition, and/or the nutritional RTD beverage may comprise a synbiotic. A synbiotic is a supplement that comprises both a prebiotic (at least one of the aforementioned) and a probiotic (at least one of the aforementioned) that work together to improve the microflora of the intestine.

The effervescent composition, the nutritional product made from the effervescent composition, and/or the nutritional RTD beverage can comprise at least one the following amino acids or any combination thereof: alanine, arginine, asparagine, aspartate, citrulline, cysteine, glutamate, glutamine, glycine, histidine, hydroxyproline, hydroxyserine, hydroxytyrosine, hydroxylysine, isoleucine, leucine, lysine, methionine, phenylalanine, proline, serine, taurine, threonine, tryptophan, tyrosine and valine.

The effervescent composition, the nutritional product made from the effervescent composition, and/or the nutritional RTD beverage can comprise at least one fatty acid or any combination thereof, for example ω-3 fatty acids such α-linolenic acid (“ALA”), docosahexaenoic acid (“DHA”) and eicosapentaenoic acid (“EPA”). The fatty acid can be derived from fish oil, krill, poultry, eggs, a plant source, algae and/or a nut source, e.g., flax seed, walnuts, almonds.

The effervescent composition, the nutritional product made from the effervescent composition, and/or the nutritional RTD beverage can comprise at least one phytonutrient. The phytonutrient can be at least one of flavanoids, allied phenolic compounds, polyphenolic compounds, terpenoids, alkaloids, or sulphur-containing compounds. Phytonutrients are non-nutritive compounds that are found in many foods. Phytonutrients are functional foods that have health benefits beyond basic nutrition, and are health promoting compounds that come from plant sources. Phytonutrient refers to any chemical produced by a plant that imparts one or more health benefit on a user. Non-limiting examples of suitable phytonutrients include:

i) phenolic compounds which include monophenols (such as, for example, apiole, carnosol, carvacrol, dillapiole, rosemarinol); flavonoids (polyphenols) including flavonols (such as, for example, quercetin, fingerol, kaempferol, myricetin, rutin, isorhamnetin), flavanones (such as, for example, fesperidin, naringenin, silybin, eriodictyol), flavones (such as, for example, apigenin, tangeritin, luteolin), flavan-3-ols (such as, for example, catechins, (+)-catechin, (+)-gallocatechin, (−)-epicatechin, (−)-epigallocatechin, (−)-epigallocatechin gallate (EGCG), (−)-epicatechin 3-gallate, theaflavin, theaflavin-3-gallate, theaflavin-3′-gallate, theaflavin-3,3′-digallate, thearubigins), anthocyanins (flavonals) and anthocyanidins (such as, for example, pelargonidin, peonidin, cyanidin, delphinidin, malvidin, petunidin), isoflavones (phytoestrogens) (such as, for example, daidzein (formononetin), genistein (biochanin A), glycitein), dihydroflavonols, chalcones, coumestans (phytoestrogens), and Coumestrol; Phenolic acids (such as: Ellagic acid, Gallic acid, Tannic acid, Vanillin, curcumin); hydroxycinnamic acids (such as, for example, caffeic acid, chlorogenic acid, cinnamic acid, ferulic acid, coumarin); lignans (phytoestrogens), silymarin, secoisolariciresinol, pinoresinol and lariciresinol); tyrosol esters (such as, for example, tyrosol, hydroxytyrosol, oleocanthal, oleuropein); stilbenoids (such as, for example, resveratrol, pterostilbene, piceatannol) and punicalagins.

ii) terpenes (isoprenoids) which include carotenoids (tetraterpenoids) including carotenes (such as, for example, α-carotene, β-carotene, γ-carotene, δ-carotene, lycopene, neurosporene, phytofluene, phytoene), and xanthophylls (such as, for example, canthaxanthin, cryptoxanthin, aeaxanthin, astaxanthin, lutein, rubixanthin); monoterpenes (such as, for example, limonene, perillyl alcohol); saponins; lipids including: phytosterols (such as, for example, campesterol, beta-sitosterol, gamma-sitosterol, stigmasterol), tocopherols (vitamin E), and γ-3, γ-6, and γ-9 fatty acids (such as, for example, gamma-linolenic acid); triterpenoid (such as, for example, oleanolic acid, ursolic acid, betulinic acid, moronic acid).

iii) betalains which include Betacyanins (such as: betanin, isobetanin, probetanin, neobetanin); and betaxanthins (non glycosidic versions) (such as, for example, indicaxanthin, and vulgaxanthin).

iv) organosulfides, which include, for example, dithiolthiones (isothiocyanates) (such as, for example, sulphoraphane); and thiosulphonates (allium compounds) (such as, for example, allyl methyl trisulfide, and diallyl sulfide), indoles, glucosinolates, which include, for example, indole-3-carbinol; sulforaphane; 3,3′-diindolylmethane; sinigrin; allicin; alliin; allyl isothiocyanate; piperine; syn-propanethial-S-oxide.

v) protein inhibitors, which include, for example, protease inhibitors.

vi) other organic acids which include oxalic acid, phytic acid (inositol hexaphosphate); tartaric acid; and anacardic acid.

The effervescent composition, the nutritional product made from the effervescent composition, and/or the nutritional RTD beverage can comprise at least one antioxidant. Antioxidants are molecules capable of slowing or preventing the oxidation of other molecules. The antioxidant can be any one of astaxanthin, carotenoids, coenzyme Q10 (“CoQ10”), flavonoids, glutathione Goji (wolfberry), hesperidin, lactowolfberry, lignan, lutein, lycopene, polyphenols, selenium, vitamin A, vitamin C, vitamin E, zeaxanthin, or any combinations thereof.

The effervescent composition, the nutritional product made from the effervescent composition, and/or the nutritional RTD beverage can further comprise ingredients such as the mineral(s) includes at least one of boron, calcium, chromium, copper, iodine, iron, magnesium, manganese, molybdenum, nickel, phosphorus, potassium, selenium, silicon, tin, vanadium, zinc, or any combinations thereof. The mineral can be in the form of any suitable ingestible salt, such as a salt of chloride.

The effervescent composition, the nutritional product made from the effervescent composition, and/or the nutritional RTD beverage can further comprise ingredients such as vitamin(s) includes vitamin A, Vitamin B1 (thiamine), Vitamin B2 (riboflavin), Vitamin B3 (niacin or niacinamide), Vitamin B5 (pantothenic acid), Vitamin B6 (pyridoxine, pyridoxal, or pyridoxamine, or pyridoxine hydrochloride), Vitamin B7 (biotin), Vitamin B9 (folic acid), and Vitamin B12 (various cobalamins; commonly cyanocobalamin in vitamin supplements), vitamin C, vitamin D, vitamin E, vitamin K, folic acid and biotin) essential in amounts for normal growth and activity of the body, or any combinations thereof.

In a further aspect, the effervescent composition, the nutritional product made from the effervescent composition, and/or the nutritional RTD beverage can be used for preventing and/or alleviating, and/or compensating swallowing dysfunction in a patient in need of such treatment. As used herein, the terms prevent, prevention, alleviate, and compensate, and compensation include prophylactic or preventive treatment (that prevent and/or slow the development of a targeted pathologic condition or disorder) and therapeutic or disease-modifying/compensation treatment, including therapeutic measures that slow down, lessen symptoms of, and/or halt progression of a diagnosed pathologic condition or disorder; and treatment of patients at risk of contracting a disease or suspected to have contracted a disease, as well as patients who are ill or have been diagnosed as suffering from a disease or medical condition. The term does not necessarily imply that a subject is treated until total recovery. The terms prevent, prevention, alleviate, and compensate, and compensation also refer to the maintenance and/or promotion of health in an individual not suffering from a disease but who may be susceptible to the development of an unhealthy condition, such as nitrogen imbalance or muscle loss. The terms prevent, prevention, alleviate, and compensate, and compensation are also intended to include the potentiation or otherwise enhancement of one or more primary prophylactic or therapeutic measure. The terms prevent, prevention, alleviate, and compensate, and compensation are further intended to include the dietary management of a disease or condition or the dietary management for prophylaxis or prevention a disease or condition.

In a further aspect, the effervescent composition, the nutritional product made from the effervescent composition, and/or the nutritional RTD beverage can be used for promoting swallowing safety and/or efficiency of nutritional products in a patient in need of same.

In a further aspect, the effervescent composition, the nutritional product made from the effervescent composition, and/or the nutritional RTD beverage can be used for mitigating the risks of aspiration during swallowing of nutritional products in a patient in need of same.

The nutritional product and/or the nutritional RTD beverage can be preferably in an administrable form, for example an orally administrable form. The administrable form can be any one of a pharmaceutical formulation, a nutritional formulation, a dietary supplement, a functional food, a Medical Food and a beverage product, or any combinations thereof.

In a further aspect, a method for making the nutritional product comprises providing the effervescent composition comprising an edible acid, a carbonate salt, optionally a thickening agent and optionally a trigeminal ingredient; and diluting the effervescent composition in a liquid to provide the nutritional product.

When the effervescent composition is being dissolved in the liquid, the effervescent action has an automatic “stirring” effect, which makes the composition dissolve easily and/or fast with little or no subsequent stirring.

Generally, the temperature of the diluent may not be critical to the preparation of the nutritional product and may include, without limitation: hot, cold, or room temperature diluent. With some particular thickeners in the effervescent composition, the inherent properties will make the choice of temperature more critical than with others.

As necessary or desired, components such as acids, bases, acidulates, chelating agents, flavors, colors, vitamins, minerals, sweeteners, insoluble foods and/or preservatives may be incorporated into the effervescent composition and diluent admixture at any appropriate point during the preparation. Such minor components are preferably present in minor amounts and concentrations, i.e. a non-substantial amount as relates to thickening.

In an exemplary embodiment, each serving of the nutritional RTD beverage disclosed herein may contain about 8 grams of high-quality protein, about 15 essential vitamins and minerals, about 180 nutritious calories, about 0 grams of fat. Each serving of the nutritional RTD beverage disclosed herein may contain any other suitable amounts of ingredients, nutrients, and/or calories. In an exemplary embodiment, depending on the specific admixing equipment used and the appropriate handling of the materials, the time for admixing the nutritional product is from about 2 minutes to about 180 minutes and preferably from about 5 minutes to about 60 minutes, although greater and lesser times may be employed if desired or necessary.

Optionally, as necessary or desired, the effervescent composition, the nutritional product made from the effervescent composition, and/or the nutritional RTD beverage may be treated to provide shelf stability. Most commonly, but not limiting, the treatment can be heat in combination with one or more of the minor components mentioned above.

The packaging of the effervescent composition, the nutritional product made from the effervescent composition, and/or the nutritional RTD beverage may not be critical as long as it delivers a product effective and/or suitable for an individual afflicted with dysphagia. Illustratively, packaging may be totes, bins, foil pouches, buckets, bags, syringes or the like. If desired, use of a thickener can facilitate in-line mixing and preparation of the nutritional product in a beverage dispenser or container. The packaging can include a metering device and/or an in-line mixing system to dispense the product. The packaging may be designed to dispense thickened or non-thickened beverages at the turn of a switch.

The nutritional product made from the effervescent composition and/or the nutritional RTD beverage can be administered to the individual suffering from dysphagia by a device (such as a Bionix SafeStraw™) configured to allow the healthcare provider to safely manage the swallowed liquid volume and help reduce aspiration risk of the individual. Such a device helps reduce aspiration risks allowing patients to safely, discreetly, and independently drink from a variety of containers such as cups and bottles. Such a device can be provided along with the packaging or provided separately. Such a device can be integrated with the metering device to deliver a specific amount of the nutritional product and/or the nutritional RTD beverage. For example, the Bionix SafeStraw™ can be used to deliver, for example, 6.2 ml per sip by the individual.

In some embodiments, the effervescent composition, the nutritional product made from the effervescent composition, and/or the nutritional RTD beverage may be packaged in a one use portion size which provides the right dosage of ingredients, and the individual or patient will have easy access whenever they want to.

The effervescent composition disclosed herein can be delivered to the end user dry or fully, completely, and totally hydrated in an airtight container, and may minimize or avoid settling or separation when shipped. Preferably, the density will not change over time, and the product is stable.

The nutritional product and the nutritional RTD beverage disclosed herein are safe to eat and to leave in the presence of persons with impaired mental judgment. Consumption of these products does not present a choking hazard. Dry powders put in the mouth and/or attempted to be swallowed before dissolving could present a danger to a patient with impaired mental judgment. In many facilities, open containers of powder are left on tables or in rooms or individual sized packets are served on trays. If a caregiver is somehow distracted, an impulsive eater, such as an individual afflicted with Huntington's chorea, could quickly try to consume the dry powder, at serious risk. The nutritional product and the nutritional RTD beverage disclosed herein are reconstituted and/or completely hydrated and thus face no such problems.

In some embodiments of the methods disclosed herein, the method comprises identifying a level of severity of the swallowing disorder in the patient; and selecting, based on the level of severity of the swallowing disorder in the patient, the amount of the effervescent composition for diluting, wherein the amount of the effervescent composition is selected from a plurality of predetermined amounts that each corresponds to a different level of swallowing disorder severity.

In another aspect, the present disclosure provides a use of the effervescent composition and a liquid in preparation of an orally administrable nutritional product, the liquid is suitable for consumption by an individual without dysphagia, the orally administrable nutritional product is suitable for administration to an individual having dysphagia.

In another aspect, the present disclosure provides a system for production of a homogenous single phase beverage for administration to an individual having dysphagia, the system comprising: a container comprising the effervescent composition; and a metering device connected to the container and configured to dispense a predetermined amount of the effervescent composition. The system can further comprise a static in-line mixer configured to mix the effervescent composition into the homogenous single phase beverage and/or a nozzle configured to dispense the homogenous single phase beverage.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1-14. (canceled)

15. A ready-to-drink (RTD) beverage formulated for administration to an individual having dysphagia, wherein the ready-to-drink (RTD) beverage has a relaxation time, determined by a Capillary Breakup Extensional Rheometry (CaBER) experiment, of more than 10 ms at 20° C. and/or a shear viscosity up to about 2,000 mPas measured at a shear rate of 50 s⁻¹ at 20° C.

16. The ready-to-drink (RTD) beverage according to claim 15 comprising at least one ingredient selected from the group consisting of proteins, vitamins, and minerals, and the ready-to-drink (RTD) beverage is fat-free.

17. A method of preventing, alleviating, and/or compensating swallowing dysfunction in a patient in need thereof, the method comprising:
providing an effervescent composition comprising an acid compound, an alkaline compound, a thickening agent and optionally a trigeminal ingredient;
dissolving the effervescent composition in a liquid to provide a nutritional product; and
orally administering the nutritional product to the patient.

18. The method according to claim 17, wherein the acid compound comprises at least one of citric acid, ascorbic acid, nicotinic acid, acetylsalicylic acid, succinic acid, adipic acid, tartaric acid, fumaric acid, adipic acid, malic acid, anhydrides, or salts thereof.

19. The method according to claim 17, wherein the alkaline compound comprises at least one ingredient selected from the group consisting of potassium carbonate, sodium carbonate, sodium bicarbonate, potassium bicarbonate, sodium glycine carbonate, calcium carbonate, arginine carbonate, potassium bitartrate, and sodium tartrate.

20. The method according to claim 17, wherein the trigeminal ingredient comprises at least one ingredient selected from the group consisting of cinnamaldehyde with zinc, cinnamaldehyde without zinc, p-anisaldehyde, cumminaldehyde, tiglic aldehyde, Sichuan pepper, capsaicin, capsiate, and isothiocyanate.

21. The method according to claim 17, wherein the thickening agent comprises at least one ingredient selected from the group consisting of xanthan gum, gum arabic, carrageenan (lambda), carrageenan (iota), carrageenan (kappa), sodium alginate, konjac, locust bean gum, carboxymethyl cellulose (CMC), chitosan, inulin, pectin (from citrus), pectin (from apple), hydroxypropyl methylcellulose (HPMC), and tara gum.

22. The method according to claim 17, wherein the thickening agent is present in an amount that provides to the nutritional product, a relaxation time, determined by a Capillary Breakup Extensional Rheometry (CaBER) experiment, of more than 10 ms at 20° C. and a shear viscosity up to about 2,000 mPas measured at a shear rate of 50 s⁻¹ at 20° C.

23. (canceled)

24. The method according to claim 17 further comprising:
identifying a level of severity of the swallowing disorder in the patient; and
selecting, based on the level of severity of the swallowing disorder in the patient, an amount of the effervescent composition for dissolving in the liquid, wherein the amount of the effervescent tablet is selected from a plurality of predetermined amounts that each corresponds to a different level of swallowing disorder severity.

25. The method according to claim 24, wherein the amount of the effervescent composition is an effective amount for administration of the nutritional product to the patient to achieve at least one of (i) supplemental nutrition, (ii) hydration or (iii) replacement of one or more full meals.

26. The method according to claim 17, wherein an amount of the effervescent composition provides, after dissolving in the liquid, an appropriate number, density, and/or size of CO2 bubbles that in turn, when in contact with salivary carbonic anhydrase, yields a concentration of carbonic acid effective to provide a trigeminal stimulation, which in turn improves swallowing safety.

27. A method of promoting swallowing safety and/or efficiency in a patient in need thereof, the method comprising:
providing an effervescent composition comprising an acid compound, an alkaline compound, a thickening agent and optionally a trigeminal ingredient;
dissolving the effervescent composition in a liquid to provide a nutritional product; and
orally administering the nutritional product to the patient.

28-70. (canceled)
